(19) United States
(12) Patent Application Publication
(10) Pub. No.: US 2003/0022683 A1
(43) Pub. Date: Jan. 30, 2003

(54) Method for transmitting multicast messages in a radio system, and correspondingly designed radio system, transmitter and receiver

(76) Inventors: Mark Beckmann, Braunschweig (DE); Martin Hans, Hildesheim (DE); Michael Eckert, Braunschweig (DE); Andreas Otte, Celle (DE)

Correspondence Address: Bell, Boyd & Lloyd LLC, P.O. Box 1135, Chicago, IL, 60690, US

(21) Appl. No.: 10/187,497

(22) Filed: Jul. 2, 2002

(30) Foreign Application Priority Data
Jul. 4, 2001 (DE) 101 32 273.9

(51) Int. Cl. H04B 1/38; H04Q 7/20

(52) U.S. Cl. 455/518; 455/519; 455/575

(57) ABSTRACT

A method is provided for transmitting multicast messages intended simultaneously for a group of receivers in a radio system, particularly a UMTS mobile radio system, wherein, before a multicast message is transmitted, a resource assignment is transmitted and a connection to the transmitter is set up in accordance with this resource assignment message by the receivers belonging to group. It is only then that the multicast message is transmitted by the transmitter to the individual receivers belonging to group via the connections thus set up.

### BACKGROUND OF THE INVENTION

Mobile radio technology is developing rapidly. At present, work is proceeding on the standardization of the so-called UMTS (Universal Mobile Telecommunication System) mobile radio system of the third mobile radio generation.

Multicast messages are messages which are simultaneously sent by a transmitter, such as by a base station in a mobile radio system, to a group of receivers (called multicast group); e.g., mobile stations. That is, the transmitter only sends a multicast message once to the receivers belonging to the respective multicast group, and it may not be known to the transmitter which of the mobile stations located within the transmitting range of the transmitter belong to the multicast group and are thus considered as receivers for the transmitted multicast message.

Although approaches for transmitting such multicast messages in mobile radio systems already have been discussed for some time, no complete and satisfactory proposals are yet known in this respect.

The present invention is, therefore, directed toward a method for transmitting multicast messages in a radio system, particularly a mobile radio system via which multicast messages can be transmitted reliably and securely with little expenditure. Furthermore, a correspondingly designed radio system with a suitable transmitter and receiver is to be provided with the aid of the present invention.

### SUMMARY OF THE INVENTION

According to the present invention, it is proposed to transmit a message for assigning or allocating resources in the radio system, particularly for assigning suitable transmission channels, before the transmission of multicast messages, when this message is evaluated by the receivers belonging to the corresponding multicast group and in each case a connection corresponding to this message is set up or configured through to the transmitter so that subsequently the multicast messages can be transmitted from the transmitter to the receivers via the previously configured connections. The multicast messages also can be, in particular, data which are distributed irregularly over time.

With the message for assigning resources in the radio system, initially transmitted by the transmitter, resources of a common transport channel and of a common physical channel under which the common transport channel is mapped are preferably assigned to the receivers belonging to the multicast group. A “common channel” is understood to be a channel which can be read or listened to by all receivers and which is, thus, not assigned to any special receiver in contrast to a so-called “dedicated channel.”

The message of the transmitter, transmitted for assigning resources, preferably contains information for configuring the common transport channel and the common physical channel so that the receivers belonging to the multicast group can configure the common transport channel and the common physical channel in accordance with this message for preparing for the transmission of multicast messages.

The message of the transmitter, provided for assigning resources, can be transmitted, in particular, via a common logical control channel and exhibit an identifier for the respective multicast group so that the individual receivers, by evaluating this identifier, can determine whether they belong to the corresponding multicast group or, respectively, the multicast messages transmitted thereafter are intended for them.

As an alternative, the message of the transmitter, provided for assigning resources, also can be transmitted via a special logical control channel which is exclusively provided for transmitting control messages for multicast groups.

Once a receiver (i.e., a mobile station in a mobile radio system) has registered for a multicast group at the transmitter end (i.e., at the network operator or mobile radio network controller in a mobile radio system), the receiver is informed of the identifier for the respective multicast group from the transmitter end.

If a receiver has received a message about the presence of multicast messages to be transmitted from the transmitter and if the receiver belongs to a multicast group, the receiver configures a corresponding multicast unit in the so-called BMC (Broadcast Multicast Controller) layer of the receiver which is connected to a corresponding RLC unit in the so-called RLC (Radio Link Control) layer of the reference model. To this RLC unit is preferably connected, via a common data channel, the so-called MAC (Medium Access Control) layer, and this common data channel is mapped onto the aforementioned common transport channel. As soon as the receiver signs off again from the corresponding multicast group, the multicast unit of this receiver is disassembled again in the BMC layer.

If all receivers belonging to the multicast group affected have set up a signaling link to the transmitter, the aforementioned message (designated as “resource assignment message” for the sake of simplicity in the text which follows) for assigning resources of the radio system to the preparation for the transmission of the multicast messages can be transmitted by the transmitter so that the receivers belonging to the respective multicast group can configure the common transport channel and the common physical channel independently of the configuration information contained in this message and a transmission of the multicast messages is then possible.

The resources (i.e., the corresponding common transport channel and the common physical channel), are preferably assigned only for a particular period of time and, for example, the individual receivers are informed of the starting time and the end time of this period of time via the resource assignment message, this common transport channel and this common physical channel preferably being cleared down again after this period of time has elapsed.

The present invention is preferably suitable for use in a mobile radio system; particularly, a UMTS mobile radio system. Naturally, however, the present invention is not restricted to this preferred field of application but can be used in any radio system in which the transmission of multicast messages is intended to be possible, attention having to be paid to the fact that both the transmitter end and the receiver end are affected by the present invention.

Additional features and advantages of the present invention are described in, and will be apparent from, the following Detailed Description of the Invention and the Figures.

### BRIEF DESCRIPTION OF THE FIGURES

FIG. 1 shows a simplified representation of a mobile radio cell of a mobile radio system for explaining the transmission of multicast messages according to the present invention.

FIG. 2 shows a state diagram for explaining the transmission of multicast messages according to a preferred exemplary embodiment of the present invention.

FIG. 3 shows a representation of a number of layers of a reference model when using the exemplary embodiment also explained with reference to FIG. 2.

FIG. 4 shows a possible structure of a multicast message or, respectively, resource assignment message according to the present invention.

FIG. 5 shows a representation of a reference model for explaining the transmission of multicast messages according to the present invention.

FIG. 6A and FIG. 6B show representations of a so-called “physical shared allocation message” according to the prior art.

### DETAILED DESCRIPTION OF THE INVENTION

In the context of the present invention, a method for transmitting multicast messages or, respectively, for resource allocation in preparation for the transmission of multicast messages, is proposed. This is done, in particular, by using a common transport channel and a common physical channel which can be assigned to different mobile stations at different times. An example of this is the channel designated as “downlink shared channel” (DSCH) in UMTS (Universal Mobile Telecommunication System) mobile radio systems. In particular, it is also described in the text which follows how the resources are assigned to individual multicast groups by signaling on a common channel; “common channel” being a channel which can be read by all mobile stations in the context of the present invention.

Since the present invention partially has commonalities with a resource assignment message already conventionally provided for UMTS mobile radio systems and transmitted for other purposes (namely, the so-called “physical shared channel allocation message”), the generation of this conventional resource assignment message will be first explained in the text which follows before the special features and details of the present invention are discussed.

The “Physical Shared Channel Allocation Message” According to UMTS

FIG. 5 shows the reference model of the protocols at the air interface according to the UMTS mobile radio standard.

Each mobile station UE consists of a physical layer PL which is responsible for the processing of the data for transmission via the air interface via physical channels 10 at the transmitter end and, at the receiving end, forwards the received data to a higher medium access control layer MAC in such a manner that they can be processed further by this layer. At the network end, the physical layer PL is located in a base station BS which is connected via a landline network connection to a radio network controller RNC of the respective mobile radio system or mobile radio network operator. The connections between the physical layer PL and the MAC layer are called transport channels 11 and specify how the data are transmitted (e.g., in common channels or in channels which are only dedicated to a particular mobile station). The MAC layer has tasks such as, for example, the identification of the users for whom a packet is intended if it is transmitted in common channels, and the mapping of logical channels 12 onto the transport channels 11. For this purpose, the MAC layer adds control information (e.g., about the identity of the mobile station) to the data packets to be transmitted, which it is has received from a radio link control layer RLC, at the transmitter end. At the receiving end, this control information is evaluated and removed again from the data packets before they are forwarded via the logical channels 12 to the RLC layer. The logical channels 12 are the connections between the MAC layer and the RLC layer.

The RLC layer is responsible for monitoring the data transmission; i.e., for detecting missing data packets and possibly for requesting them again. In the RLC layer, a number of units can be defined. Each RLC unit is connected to a connection between higher layers and RLC (e.g., radio bearers). The RLC layer, too, can add control information to the data packets received by it from the higher layers at the transmitter end. This control information is used at the receiving end for assessing (e.g., whether data packets are missing), and is removed from the data packets before they are forwarded again to the higher layers.

Above the RLC layer, there is a radio resource control layer RRC which is responsible for the configuration of the layers below and especially for setting up the connection. The connections 13 between the RLC layer and the RRC layer are called “signaling radio bearers” (SRB). In addition, there are so-called “radio bearers” above the RLC layer which are used for the actual data transmission and represent the connection 14 between the RLC layer and the application above. If packet data are transmitted, there is also a so-called packet data convergence protocol layer PDCP above the RLC layer, which is responsible, for example, for the compression of IP (Internet Protocol) packets. There is also above the RLC layer a so-called “broadcast multicast controller” layer BMC which is used for receiving so-called cell broadcast messages. In the BMC layer, a number of BMC units can be defined similar to the RLC layer.

A so-called DSCH (Downlink Shared Channel) channel has already been specified for UMTS for transmitting, in particular, packet data. The DSCH is a transport channel 11 which is mapped onto a physical channel PDSCH (Physical Downlink Shared Channel). The special feature of this channel is that a radio network controller RNC can reserve resources within a radio cell and assign the resources to a particular mobile station UE for a particular time so that it is a resource dedicated to only this one mobile station UE within the time specified. This makes it possible to send irregularly occurring data traffic to the mobile station in an efficient manner.

In UMTS, two different modes are defined by the TDD (Time Division Duplex) and the FDD (Frequency Division Duplex) modes. In the case of the TDD mode, the PDSCH resource of the RRC layer is assigned in the radio network controller RNC via a “physical shared channel allocation” message to a mobile station UE which is sent to the mobile station either via a common channel which can be read simultaneously by all mobile stations UE, or via a channel which is assigned to only one particular mobile station UE. In UMTS, the common transport channel 11 which can be read simultaneously by a number of mobile stations UE and in which messages can be sent from a network to the mobile stations UE is called the FACH channel (Forward Access Channel). This common transport channel 11 is mapped, in the physical layer PL, onto a common physical channel 10 called SCCPCH (Secondary Common Control Physical Channel) in UMTS. In a case where the message is sent via a common channel, the message contains an identifier for the mobile station for which this message is intended.

In the context of the present invention, the transmission of the RRC message “physical shared channel allocation message” in common channels is particularly of interest. For this reason, this case will be predominantly considered in the text which follows.

Furthermore, the transmission of the aforementioned message can be divided into two subcases in this case.

In the first case, the RRC message “physical shared channel allocation message” is handed from the RLC layer to the MAC layer via a logical channel 12 assigned to only one particular mobile station UE for resource allocation in the radio network controller RNC and in the mobile station UE is forwarded from the MAC layer to the RLC layer also via such a logical channel assigned to only the mobile station. Such a logical channel 12 assigned to only one mobile station UE is called DCCH (Dedicated Control Channel) in UMTS. In this process, the RLC layer in the radio network controller RNC can also add control information to the message before this packet is forwarded to the MAC layer. Since data for other mobile stations are also transmitted in the common transport channel (FACH), the MAC layer in the radio network controller RNC always adds certain control information to a message when the MAC layer has received it via the DCCH channel from the RLC layer and is to forward it in the common FACH transport channel. Using the control information, the MAC layers in the mobile stations can determine, among other things, whether the message is intended for them.

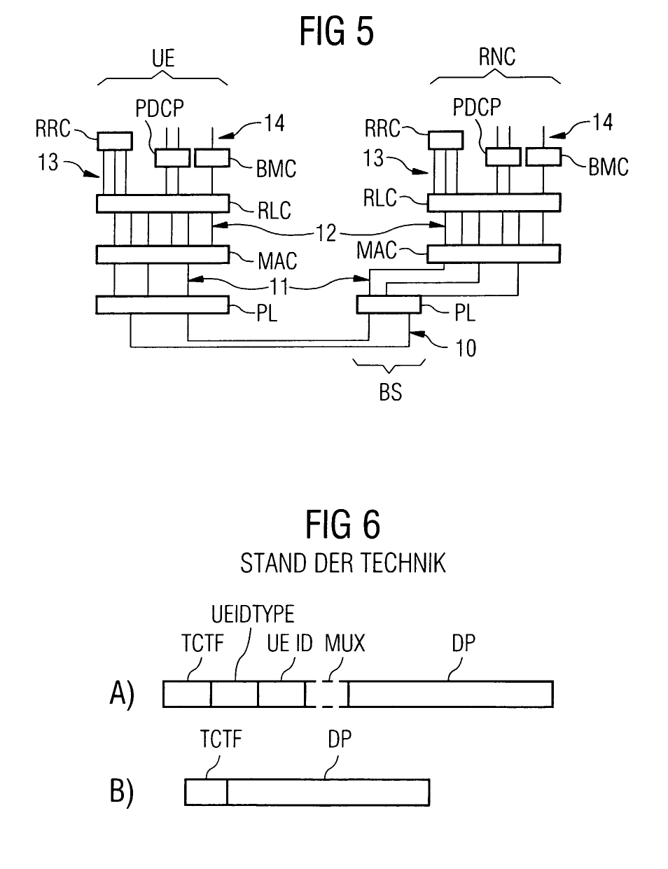

For this purpose, the control information consists, as shown in FIG. 6A, of, among other things, a field UEIDTYPE which specifies what the identification of the mobile station looks like and a field UEID which contains the actual identification for the respective mobile station. In addition, the MAC control information also includes a TCTF (Target Channel Type Field) and a MUX field. The control information TCTF specifies the logical channel via which a data packet, which is to be forwarded in a common transport channel (FACH), has been handed to the MAC layer. This is necessary since the control information added to the data packet at the transmitter end differs depending on which logical channel the data packets come from, which are to be forwarded via a common transport channel. Thus, if the TCTF field contains information that the packet has been handed to the MAC layer via a logical DCCH channel, the receiving mobile station knows that the control information consists of the fields described above. The MUX field is used for demultiplexing if a number of logical channels are mapped onto the respective common transport channel. In addition, the message contains a data packet DP with the actual message information, which has been received by the MAC layer from the RLC layer; i.e., the data packet includes an RRC message and any RLC control information items added.

The message shown in FIG. 6A is thus forwarded via the respective common transport channel (FACH) 11 to the physical layer PL which sends the message via a common physical channel (SCCPH) 10 to all mobile stations UE in the cell which have set up a signaling link to the radio network control RNC. The configuration of the common transport channel 11, the physical channel 10, the logical channel (DCCH) 12, the RLC layer, the MAC layer and the physical layer PL has been made known to all mobile stations during the setting-up of the signaling link so that all mobile stations can receive the message. The MAC layers of the mobile stations then check the identity of the mobile station for which the message has been sent. The mobile stations which are not identified via the identity specified in the UEID field discard the message. The mobile station which is identified via the identity removes the MAC control information from the message and forwards the remaining message via the corresponding logical channel (DCCH) 12 to the RLC layer which also evaluates the RLC control information and then forwards the message packet to the RRC layer.

In the second case, the RRC layer itself adds to the RRC message “physical shared channel allocation message” an information item via which the mobile station is identified for which this message is intended. The message is forwarded to the RLC layer which may add RLC control information to the message and then forwards this data packet to the MAC layer by a common logical channel SHCCH (Shared Channel Control Channel) 12. The MAC layer adds the certain MAC control information to all data packets which it has received from a logical channel (SHCCH) 12. As shown in FIG. 6B, this information only consists of the TCTF field which is assigned the value SHCCH in this case. The data packet is then forwarded via a common transport channel (FACH) 11 to the physical layer PL which sends the message via the air interface in a common physical channel (SCCPH) 10. The configuration of the common transport channel 11, the common physical channel 10, the logical channel (SHCCH) 12, the RLC layer, the MAC layer and the physical layer PL has again been made known to all mobile stations during the setting-up of the signaling link so that all mobile stations can receive the message. The mobile stations within the radio cell forward the message to the RRC layer via the MAC layer and the RLC layer. The MAC layers of the mobile stations remove the MAC control information and forward the message to the RLC layer via the corresponding logical channel (SHCCH) 12 on the basis of the information contained in the TCTF field. In the RLC layer, the RLC control information is removed and the message is forwarded to the RRC layer. It is only in the RRC layer that a check of which mobile station the message has been sent from is made via the information contained in the message. The message is only used by the mobile station which is identified via the appended identity. The message is discarded by all other mobile stations.

In the two cases described, the PDSCH message contains information about, for example, the period of time within which the PDSCH resources are available for the mobile station, and the configuration of the physical channel 10. As an alternative, one or more configurations of the PDSCH channel also can be distributed in the entire cell via the system information and the corresponding configuration can be referred to only with an identifier in the message for assigning the PDSCH resources. In the case where the message is sent via a channel assigned to only one mobile station (called dedicated channel (DCH) in the text which follows), the message is only read by the mobile station for which it was intended.

In the case of the FDD mode, the resource assignment takes place via a channel assigned only to the respective mobile station (dedicated channel). Via this channel, the mobile station is informed via a special field TFCI (Transport Format Combination Identifier) that data will be transmitted for the mobile station on the PDSCH channel in the next time window or frame. The TFCI field is used for designating, with respect to the different transport formats, the size and number of the data packets which are transmitted by different logical channels 12 (i.e., the channels between the RLC layer and the MAC layer) within such a time window. If a certain allocation of the TFCI field is used, this indicates to the mobile station that a transmission will take place in the PDSCH channel in the next time window. The mobile station has been informed of the configuration of the PDSCH channel during the setting-up of the transmission link.

With regard to the RRC layer, a distinction is made between different RRC states. The PDSCH channel and DSCH channel only exist in the RRC states CELL_FACH and CELL_DCH in TDD mode and only in the RRC state CELL_DCH in the FDD mode. The DSCH/PDSCH channel is not available in the CELL_PCH and URA_PCH states and in IDLE MODE.

The different states express the level at which the position of the mobile station is known and what resources are, in each case, available.

In the RRC state CELL_DCH, the mobile station is assigned dedicated resources and the mobile station is known at cell level; i.e., the network knows which cell the respective mobile station is located in.

In the RRC state CELL_FACH, the mobile station is assigned common resources which it must share with other mobile stations. In this state, the mobile station is also known at cell level.

In the RRC state CELL_PCH, the mobile station receives radio messages from the network and hears the paging channels PICH (Paging Indictor Channel) and PCH (Paging Channel) via which the network can inform the mobile station that, for example, messages are present for the respective mobile station. In this state, the mobile station is known at cell level.

The RRC state URA_PCH is similar to the CELL_PCH but with the difference that the position of the mobile station is not precisely known to the network but the network only knows the group of cells in which the mobile station would be located.

In IDLE MODE, the mobile station also receives radio messages from the network and hears the paging channels PICH and PCH. In contrast to the URA_PCH and Cell_PCH states, however, the radio network controller RNC has no knowledge about the mobile station itself or whether the mobile station is located in one of the cells controlled by it.

The paging mechanism consists of two stages. In the first step, the network informs the mobile station via an indicator in the PICH channel that there are messages for the mobile station in the PCH channel. It is only then that the mobile station reads out the PCH channel containing the actual notification.

The Transmission of Multicast Messages of the Present Invention

Building on the principle described in connection with the physical shared channel allocation message, a transmission of multicast messages in a radio system, particularly a mobile radio system, is proposed in the context of the present invention. Ideally, the multicast messages are to be transmitted only once to a number of mobile stations at the same time within a radio cell. The data to be transmitted can be distributed irregularly over time so that a transmission via a channel similar to the DSCH channel would be advantageous.

An essential component of this is the assignment of resources of a common transport channel 11 and of a common physical channel 10 to the transmission of multicast messages similar to the DSCH/PDSCH channels existing in UMTS. This is done, in particular, via a resource assignment message which also will be called “multicast channel allocation message” in the text which follows and contains the configuration of the common transport channel 11 and of the common physical channel 10. As an alternative, it also is possible to distribute configurations together with identifiers to all mobile stations within a cell and only to send the respective identifier for selecting the desired configuration to a group of mobile stations in the resource assignment message. Furthermore, the message should advantageously contain an information item on the start and end of a time interval within which the respective resource is assigned to the group of mobile stations; i.e., to the multicast group.

The resource assignment message “multicast channel allocation message” can be sent in two different ways to all mobile stations UE in a cell which has set up a signaling link to the radio network controller RNC.

In the first case, the resource assignment message is sent via a common logical control channel, such as the SHCCH channel in UMTS, and exhibits an identifier for the respective multicast group. The RRC layers of the mobile stations UE, in each case, determine whether the message is intended for the corresponding mobile station or not.

In the second case, the resource assignment message is transmitted via a new special logical control channel which should only be used for the transmission of control messages for multicast groups. In the text which follows, this special logical channel will be called MCCCH (Multicast Control Channel) channel. In this case, the MAC layer of the radio network controller RNC maps the logical MCCCH channel onto a common transport channel 11. When the common FACH transport channel 11 is used, the MAC layer adds the control information item TCTF to the message and assigns the value MCCCH to this control information item. In addition, the MAC layer adds to the message a further control information item MCID which identifies the multicast group for which the multicast channel allocation message is intended. The complete message with the multicast channel allocation message including any RLC control information (reference symbol DP), the TCTF field and the MCID field is shown in FIG. 4 and is provided with the reference symbol SN. Only the MAC layers of the mobile station UE belonging to the multicast group designated by the MCID field advantageously forward the message to the RLC layer.

In the case where the mobile stations UE are in the IDLE MODE state or in the RRC states URA_PCH or CELL_PCH in the connected state, the presence of multicast messages is specified as the reason for the notification in a paging message sent to the mobile stations. In particular, “Paging Type 1” or “Paging Type 2” already in existence are used and the reason for the notification via this message is specified in an information element “paging cause” in that a further value “multicast message” is added to this information element.

A mobile station UE which belongs to a multicast group configures at least one multicast unit in the BMC layer which is connected to an RLC unit in the RLC layer. The RLC unit is also connected to the MAC layer via a common data channel (CTCH). For the purpose of data transmission, the CTCH channel is also mapped, in the MAC layer, onto a common transport channel 11 for transmitting multicast messages, this common transport channel 11 being mapped onto a common physical channel 10 in the physical layer PL. Once all mobile stations UE belonging to the respective multicast group for which there are messages for transmission have set up a signaling link to the radio network controller RNC, the latter sends the resource assignment message “multicast channel allocation message.” The mobile stations UE are informed during the setting-up of the signaling link about which logical channel 12 (DCCH or MCCCH) is to be used for this purpose. The mobile stations UE belonging to the corresponding multicast group thereupon set up the common transport channel 11 and the common physical channel 10 for transmitting multicast messages in accordance with the configuration specified in the resource assignment message.

The functions described above also can be represented as a state diagram. The state diagram is shown in FIG. 2 and the individual states 100-103 can be characterized as follows:

In the state 100, which also can be called “MC-null”, the respective mobile station does not belong to any multicast group and, accordingly, the network does not attempt to notify the mobile station when there is a multicast message for transmission.

In a state 101, which also can be called “MC_saving”, the respective mobile station belongs to a multicast group and there is a corresponding multicast unit in the BMC layer. The mobile station passes from state 100 into state 101 by registering for a first multicast group in the network, the network then informing the mobile station of an identifier for the respective multicast group (state transition 1 in FIG. 2). In state 101, the mobile station reads out radio messages and also hears the paging channels PICH and PCH. The network notifies the mobile station about the paging channels PICH and PCH when there are multicast messages for transmission. The state 101 corresponds to the RRC states IDLE MODE, CELL_PCH and URA_PCH. A return into the state 100 takes place when the mobile station signs off from all multicast groups and the corresponding multicast unit in the BMC layer is deleted (state transition 2).

If the mobile station receives a notification that there are multicast messages to the corresponding multicast group to which the mobile station belongs, the mobile station sets up a signaling link to the network and changes into a state 102 (state transition 3).

In the state 102, which also can be called “MC_monitoring”, the mobile station thus belongs to a multicast group, there is a multicast unit in the BMC layer, and there is a signaling link between the mobile station and the radio network controller RNC and the mobile station can receive RRC messages at any time in a common channel (e.g., the common FACH transport channel). This state 102 corresponds to the RRC state CELL_FACH or CELL_DCH. For this purpose, the mobile station must be extended in comparison with the prior art in such a manner that a common channel also can be received whenever the mobile station is in the RRC state CELL_DCH.

The mobile station then receives from the network the resource assignment message via which the resources of a common transport channel and of a common physical channel are assigned to the mobile station for the transmission of multicast messages. The mobile station sets up the common transport channel and the common physical channel for receiving multicast messages and changes into a state 103 (state transition 4).

In the state 103, which also can be called “MC_active”, the mobile station thus belongs to a multicast group, there is a multicast unit in the BMC layer, and the mobile station has set up a common transport channel and a physical channel for the transmission of multicast messages. In addition, the multicast unit is connected to an RLC unit in the RLC layer, the RLC unit being connected to the MAC layer by a common logical data channel (CTCH channel). The common logical data channel is mapped onto the common transport channel for the transmission of multicast messages. The mobile station can now receive multicast messages via this common transport channel and the common physical channel. The messages are forwarded via the common logical data channel (CTCH) to the corresponding RLC unit and from the latter to the multicast unit in the BMC layer. The multicast unit in the BMC layer uses a multicast address contained in the multicast message for forwarding the message to a corresponding application.

After the period of time specified in the resource assignment message has elapsed, the mobile station clears down again the common transport channel and common physical channel provided for the transmission of multicast messages. If the signaling link between the mobile station and the network remains for the time being, a return to the state 102 (state transition 5) takes place. If, in contrast, the signaling link between the mobile station and the network is also cleared down, a return to the state 101 (state transition 6) takes place. A change from state 101 to state 103 takes place when the network informs the mobile station to change to the RRC state CELL_PCH.

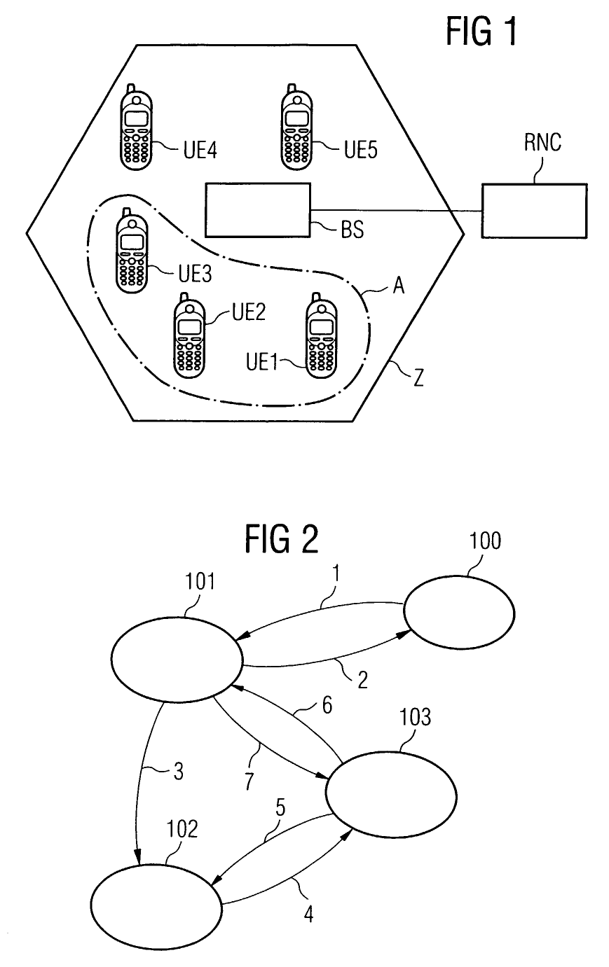

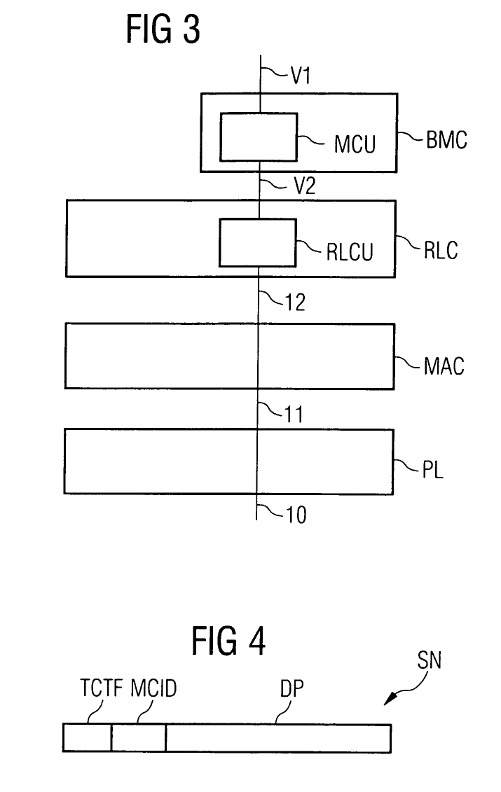

In the text which follows, the procedure explained in general terms above will be explained in greater detail via a preferred exemplary embodiment, referring to FIGS. 1 and 3.

FIG. 1 shows the configuration of a radio network as specified, for example, for the UMTS mobile radio standard. A number of mobile stations UE1-5 are located in a radio cell Z which is covered by a base station BS and to which the mobile stations are connected and with which they communicate via air interfaces. The base station BS, in turn, is connected to a radio network controller RNC via a landline connection. It is assumed that the mobile stations UE1-3 belong to a multicast group A whereas the mobile stations UE4 and UE5 do not belong to any multicast group according to this exemplary embodiment. These mobile stations are, thus, in multicast state 100 (compare FIG. 2).

It also will be assumed that the mobile station UE1 is in RCC state IDLE MODE and the mobile station UE2 is in RRC state CELL_PCH. Mobile stations UE1 and UE2 are thus in multicast state 101 (compare FIG. 2) and, accordingly, have set up a multicast unit MCU in the BMC layer (compare FIG. 3) which is connected to the applications above it via a connection V1 and to an RLC unit RLCU (compare FIG. 3) of the RLC layer via a further connection V2. The RLC unit RLCU, in turn, is connected to the MAC layer via a common logical data channel 12 (e.g., the CTCH channel). In this state, there is not yet a common transport channel and no common physical channel for the transmission of multicast messages. The mobile stations UE1 and UE2 listen to the paging channels PICH and PCH.

According to this exemplary embodiment, the mobile station UE3 is to be in RCC state CELL_FACH, i.e., mobile station UE3 has set up a signaling link to the radio network controller RNC and can receive signaling messages. The mobile station UE3 is, thus, in multicast state 102. The mobile station also has set up a multicast unit MCU in the BMC layer. This is connected to the applications above it via a connection V1 and to an RLC unit RLCU of the RLC layer via a further connection V2. The RLC unit, in turn, is connected to the MAC layer via a common logical data channel 12. In this state, there is also not yet a common transport channel 11 and no common physical channel 10 for the transmission of multicast messages.

The signaling link via which a mobile station receives the resource assignment message “multicast channel allocation message” can be configured in two different ways. In both cases, the signaling link is set up in such a manner that the message passes via a common physical channel 10 (e.g., the SCCPCH channel) to the physical layer PL where it is forwarded to the MAC layer via a common transport channel 11 (e.g., the FACH channel). In the first case (case A), the message is forwarded in a common logical control channel 12 (e.g., the SHCCH channel) to the RLC layer which finally forwards the message to the RRC layer. It is only the RRC layer which then checks via the information about the multicast group to which this message has been sent whether the message is relevant to its own mobile station or not. In the second case (case B), the MAC layer checks via the MAC control information which specifies the multicast group for which the message is intended, whether the message is intended for the respective mobile station or not. The MAC layer then forwards the message to the RLC layer via a logical control channel 12 (i.e., the aforementioned special MCCCH channel), only messages intended for this mobile station being forwarded in this logical control channel 12. The RLC layer then forwards the message to the RRC layer.

It is then assumed that a message for multicast group A arrives at the radio network controller RNC. The radio network controller RNC knows that mobile stations UE2 and UE3 are located in cells which are controlled by itself. In addition, the radio network controller RNC knows that they belong to multicast group A. Since mobile station UE1 is in an RRC state IDLE MODE, the precise cell in which mobile station UE1 is located is not known to the radio network controller RNC. The radio network controller RNC, therefore, sends a notification for mobile station UE1 in all cells in which mobile station UE1 is assumed. A notification is also sent to mobile station LE2. Since, however, it is known to the radio network controller RNC that mobile station UE2 is located in cell Z, this notification is only sent in this cell Z.

The notifications of the radio network controller RNC explained above advantageously contain information which specifies the reason for the notification; namely, the presence of multicast messages. In particular, the RRC messages “Paging Type 1” and “Paging Type 2” already in existence, which already contain an information item “paging cause” (that is, the reason for the notification), can be used for the notifications. For this purpose, a value “multicast message present”, for example, can be added to the range of values of this information item “paging cause.”

The mobile station UE1 which is in RRC state IDLE MODE has not yet set up a signaling link to the radio network controller RNC. After receiving the aforementioned notification, the mobile station UE1, therefore, first sets up a signaling link (RRC link) to the radio network controller RNC. The mobile station UE2 which is in RRC state CELL_PCH reactivates its signaling link by confirming to the radio network controller RNC that it is located in cell Z by sending an RRC message. The mobile stations UE1 and UE2 have thus set up a signaling link and are in RRC state CELL_FACH. They are now able to receive signaling messages on a common transport channel 11 (e.g., the FACH channel) and a common physical channel 10 (e.g., the SCCPCH channel). As has already been described for mobile station UE3, the signaling link can be configured in two different ways for receiving the resource assignment message “multicast channel allocation message” from the radio network controller RNC (case A or case B) (compare above). Thus, the mobile stations UE1, UE2 and UE3 are now in the multicast state 102 (compare FIG. 2).

If the signaling link transmitting the “multicast channel allocation message” message is configured according to case A, the RRC layer of the radio network controller RNC now sends a signaling message to the RLC layer which may add control data and then forwards them to the MAC layer in a common logical control channel 12 (e.g., the SHCCH channel). The MAC layer recognizes that the message has passed from the RLC layer to the MAC layer in a common control channel and is to be forwarded to the physical layer PL via a common transport channel. The MAC layer, therefore, adds a control information item TCTF to the message and assigns the value “SHCCH” to this information item. The message is then forwarded via a common transport channel 11 (e.g., the FACH channel), to the physical layer PL which sends it to all mobile stations in cell Z which are in the RRC state CELL_FACH or CELL_DCH, via a common physical channel 10 (e.g., the SCCPCH channel). In the present exemplary embodiment, these are mobile stations UE1-5. These mobile stations receive the message in the common physical channel 10 and forward it to their physical layers PL which forward the message to the MAC layers in the common transport channel 11. The MAC layers find out from the TCTF field of the MAC control information that the message is to be forwarded in the common logical SHCCH control channel. The MAC layers then remove the MAC control information and forward the message to the RLC layers via the common logical SHCCH control channel. The RLC layers, in turn, now remove any control information which may be present and forward the message to the RRC layers above them.

The resource assignment message contains the configuration of the common transport channel 11 and of the common physical channel 10 which are to be used for the subsequent transmission of the multicast messages. In addition, it contains an identifier for the multicast group A and a start and an end time which specify how long the resource is to be assigned to the multicast group A. As an alternative, one or more configurations of the common transport channel 11 and of the common physical channel 10 which are to be used for the transmission of multicast messages also can be sent once to all mobile stations of cell Z and identifiers assigned to the configurations. For this case, the resource assignment message contains only the respective identifier instead of the actual configuration so that the mobile stations can deduce from this the desired configuration.

Since the mobile stations UE1-5 are in the RRC state CELL_FACH in this exemplary embodiment, they receive this resource assignment message. Since, however, only mobile stations UE1-3 belong to multicast group A, mobile stations UE4 and UE5 discard the resource assignment message since they are not identified via the multicast address or multicast identifier contained in this message. Mobile stations UE1, UE2 and UE3 recognize from the multicast identifier that multicast messages are to be transmitted for them.

If the signaling link for transmitting the resource assignment message is configured in accordance with case B, the RRC layer of the radio network controller RNC now sends a signaling message to the RLC layer which may add control data to the message and subsequently forwards it to the MAC layer in the logical multicast control channel (MCCCH) 12. The MAC layer recognizes that the message has passed from the RLC layer to the MAC layer in a logical multicast control channel and is to be forwarded to the physical layer PL via a common transport channel 11. For this reason, the MAC layer adds to the message the control information item TCTF, to which the value “MCCCH” is assigned, and the MCID field which contains the multicast group identifier (compare FIG. 4). The message is then forwarded to the physical layer PL which sends it via a common physical channel 10 (e.g., the SCCPCH channel) to all mobile stations in cell Z which are in the RRC state CELL_FACH or CELL_DCH (to mobile stations UE1-5 in the present case). These receive the message in the common physical channel 10 and forward it to the physical layers PL which forward the message to the MAC layers in the common transport channel 11. The MAC layers find out from the TCTF field of the MAC control information that the message is to be forwarded in the special logical multicast control channel (MCCCH) 12. The MAC layers also recognize from this that another control data field MCID follows. The MAC layer of each mobile station then determines whether the respective mobile station is identified via the identifier specified in the MCID field. In the present exemplary embodiment, this is the case for mobile stations UE1-3. Their MAC layers thus remove the control information and forward the message to the RLC layers above them via the MCCCH channel. The RLC layers then, in turn, remove any control information which may be present and forward the message to the RRC layers. The RRC layers no longer need to check in this case whether the message was sent for a multicast group to which the respective mobile station belongs since this already has happened in the MAC layers. As has been mentioned already, the resource assignment message contains the configuration of the common transport channel 11 and of the common physical channel 10 which are to be used for the transmission of the multicast message. In addition, it contains information about the start and end time which specifies the length of time for which the resource is to be assigned to multicast group A. As an alternative, one or more configurations of the common transport channel 11 and of the common physical channel 10, which are to be used for the transmission of multicast messages, can be sent to all mobile stations of cell Z and corresponding identifiers that have been assigned to the configurations. For this case, the resource assignment message only contains the identifier for selecting the respective configuration, instead of the actual configuration.

Mobile stations UE1, UE2 and UE3 then configure the common transport channel 11 and the common physical channel 10 which are to be used for the transmission of multicast messages in accordance with the information contained in the resource assignment message.

The configuration of the BMC layer, the RLC layer, the MAC layer and physical layer PL is shown in FIG. 3.

The BMC layer is already configured in such a way that a multicast unit MCU has been set up within the BMC layer. According to the present invention, this multicast unit is intended to receive all multicast messages of the multicast group A and to forward them to the desired application of the multicast group A via the connection V1 above it. Furthermore, there is already a further connection V2 between the multicast unit MCU in the BMC layer and an RLC unit RLCU in the RLC layer. The RLC unit is connected to the MAC layer via a common logical channel 12 for transmitting general data, called CTCH (Common Traffic Channel) in UMTS. Within the MAC layer, this common logical channel 12 is mapped onto the new configured common transport channel 11 which is to be used for the transmission of the multicast messages and, in turn, onto the common physical channel 10 provided for the transmission of the multicast messages in the physical layer PL.

At the start time defined in the resource assignment message, the mobile stations UE1-3 begin to receive data in the common physical channel 10. At the same time, the radio network controller RNC begins to send the multicast messages. During this process, the multicast message packets sent contain an identifier of the multicast group addressed in each case, multicast A in the present case. The multicast message packets received are forwarded via the common transport channel 11 and the logical channel 12 to the corresponding RLC unit RLCU and forwarded by the latter to the multicast unit MCU in the BMC layer via the connection V2. In the multicast unit MCU, the multicast message is forwarded to the corresponding application via the further connection V1.

As has been mentioned already, a start and end time which describe the time interval for the duration of which the resources of the common transport channel 11 and of the common physical channel 10 have been assigned to multicast group A is specified in the signaling message. If this time interval has elapsed, the radio network controller RNC terminates the transmission of multicast messages to this multicast group. Mobile stations UE1-3 clear down the common transport channel 11 and the common physical channel 10. If the mobile stations also clear down the signaling links (i.e., change into RRC state IDLE MODE or into RRC state URA-PCH or CELL_PCH, respectively), they are in multicast state 101 according to the present invention. If the signaling link remains, they are in RRC state CELL_FACH or CELL_DCH; i.e.; the corresponding mobile station is in multicast state 102 (compare FIG. 2) according to the present invention after the clear down of the common transport channel 11 and of the common physical channel 10.

Although the present invention has been described with reference to specific embodiments, those of skill in the art will recognize that changes may be made thereto without departing from the spirit and scope of the present invention as set forth in the hereafter appended claims.

1. A method for transmitting multicast messages in a radio system, wherein a multicast message to be transmitted by a transmitter is intended for a group of receivers, the method comprising the steps of:
transmitting a resource assignment message, via the transmitter and before a multicast message is transmitted, for assigning resources of the radio system for the transmission of the multicast message;
evaluating the transmitted resource assignment message via the receivers belonging to the group;
setting up a connection to the transmitter, via the receivers belonging to the group, in accordance with the resource assignment message; and
transmitting the multicast message, via the transmitter, to the individual receivers belonging to the group via the setup connections.

2. A method for transmitting multicast messages in a radio system as claimed in claim 1, wherein the receivers belonging to the group are assigned resources of a common transport channel and of a common physical channel of the radio system, which is mapped onto the common transport channel at a transmitter end, with the transmitted resource assignment message.

3. A method for transmitting multicast messages in a radio system as claimed in claim 2, wherein the resource assignment message includes configuration information for configuring the common transport channel and the common physical channel, and wherein the receivers belonging to the group, after receiving the resource assignment message, configure the common transport channel and the common physical channel in accordance with the configuration information.

4. A method for transmitting multicast messages in a radio system as claimed in claim 3, wherein the configuration information of the resource assignment message includes an identifier for selecting a particular configuration from a plurality of predetermined configurations of the common transport channel and the common physical channel.

5. A method for transmitting multicast messages in a radio system as claimed in claim 2, wherein the resource assignment message includes an information item on a period of time during which the resources of the radio system are to be assigned, and wherein the receivers belonging to the group again clear down the setup connections to the transmitter for the transmission of multicast messages after the period of time has elapsed.

6. A method for transmitting multicast messages in a radio system as claimed in claim 1, wherein the resource assignment message is transmitted by the transmitter to the receivers belonging to the group if they have already set up a signaling link to the transmitter.

7. A method for transmitting multicast messages in a radio system as claimed in claim 1, wherein the resource assignment message includes an identifier identifying the group, such that the receivers respectively determine, by evaluating the identifier, whether the resource assignment messages are intended for them and only evaluate the resource assignment message if this is the case.

8. A method for transmitting multicast messages in a radio system as claimed in claim 7, wherein the resource assignment message is transmitted via a common logical control channel at a transmitter end, such that an RRC layer of the receivers respectively determines by evaluation of the identifier whether the resource assignment message is intended for the corresponding receiver.

9. A method for transmitting multicast messages in a radio system as claimed in claim 7, wherein the resource assignment message is transmitted via a logical control channel specially provided for the transmission of multicast control information at a transmitter end, and wherein an MAC layer of the receivers in each case determines by evaluation of the identifier whether the resource assignment message is intended for the corresponding receiver.

10. A method for transmitting multicast messages in a radio system as claimed in claim 9, wherein the MAC layer of a receiver forwards the resource assignment message to an RLC layer of the corresponding receiver.

11. A method for transmitting multicast messages in a radio system as claimed in claim 9, wherein an MAC layer of the transmitter maps the special logical control channel onto a common transport channel for the transmission of the resource assignment message to the receivers.

12. A method for transmitting multicast messages in a radio system as claimed in claim 8, wherein an MAC layer of the transmitter adds a control information item designating a type of logical control channel used to the resource assignment message.

13. A method for transmitting multicast messages in a radio system as claimed in claim 7, wherein an MAC layer of the transmitter adds a control information item with an identifier identifying the respective group of receivers to the resource assignment message.

14. A method for transmitting multicast messages in a radio system as claimed in claim 1, wherein the transmitter transmits a notification about a presence of the multicast message via the radio system if a multicast message to be transmitted is present.

15. A method for transmitting multicast messages in a radio system as claimed in claim 14, wherein the transmitted notification includes an information item on a reason for the notification, which is occupied with a note referring to the presence of the multicast message to be transmitted.

16. A method for transmitting multicast messages in a radio system as claimed in claim 1, wherein a receiver registers at the transmitter via the radio system for association with the group, such that the transmitter informs the receiver about an identifier identifying the group via the radio system.

17. A method for transmitting multicast messages in a radio system as claimed in claim 16, wherein the receiver, after having been allocated to the group, configures in a BMC layer at least one corresponding multicast unit which is connected to a corresponding RLC unit in an RLC layer of the receiver.

18. A method for transmitting multicast messages in a radio system as claimed in claim 17, wherein the RLC unit is connected to a MAC layer of the receiver via a common logical control channel.

19. A method for transmitting multicast messages in a radio system as claimed in claim 2, wherein the RLC unit is connected to an MAC layer of the receiver via a common logical control channel, and the common logical control channel is connected to the common transport channel via the MAC layer.

20. A method for transmitting multicast messages in a radio system as claimed in claim 17, wherein the RLC unit is dissolved when the receiver signs off from the group.

21. A method for transmitting multicast messages in a radio system as claimed in claim 17, wherein the receiver sets up a signaling link to the transmitter when receiving a corresponding notification of the transmitter about a presence of a multicast message to be transmitted.

22. A method for transmitting multicast messages in a radio system as claimed in claim 21, wherein the transmitter transmits the resource assignment message when all receivers belonging to the group for which the respective multicast message is intended have set up a signaling link to the transmitter.

23. A method for transmitting multicast messages in a radio system as claimed in claim 22, wherein the receivers are informed by the transmitter during the setting-up of the signaling link about which logical channel is used for the transmission of the resource assignment message.

24. A method for transmitting multicast messages in a radio system as claimed in claim 5, wherein the receiver sets up a signaling link to the transmitter when receiving a corresponding notification of the transmitter about a presence of a multicast message to be transmitted, and after the period of time provided in accordance with the resource assignment message has elapsed, the signaling link between the receivers belonging to the group and the transmitter is also cleared down in addition to the common transport channel and the common physical channel.

25. A method for transmitting multicast messages in a radio system as claimed in claim 1, wherein the radio system is a mobile radio system, the transmitter corresponds to a network end of the mobile radio system and the receivers respectively correspond to mobile stations.

26. A method for transmitting multicast messages in a radio system as claimed in claim 25, wherein the radio system is a UMTS mobile radio system.

27. A radio system for transmitting multicast messages, comprising a transmitter for transmitting multicast messages which are intended for a group of receivers, the transmitter being designed such that it transmits a resource assignment message for assigning resources of the radio system for transmission of the multicast message before the transmission of the multicast message, and the receivers belonging to the group being designed such that they evaluate the resource assignment message transmitted by the transmitter and respectively set up a connection to the transmitter in accordance with this resource assignment message, wherein the transmitter transmits the multicast message to the individual receivers belonging to the group via the connections set up by the receivers belonging to the group.

28. A transmitter for transmitting multicast messages in a radio system, the multicast message being intended for a group of receivers in the radio system, the transmitter comprising parts for transmitting a resource assignment message for assigning resources of the radio system for the transmission of the multicast messages before the transmission of a multicast message and parts for transmitting the multicast message to the individual receivers belonging to the group via a connection which the individual receivers, after receiving the resource assignment message, have set up in accordance with the resource assignment message.

29. A receiver for receiving multicast messages in a radio system, a multicast message being intended for a group of receivers in the radio system, the receiver comprising parts for evaluating a resource assignment message transmitted by a transmitter before the multicast message is transmitted, and parts for setting up a connection to the transmitter in accordance with the resource assignment message if the receiver belongs to the group of receivers for which the multicast message is intended, in order to receive a multicast message transmitted by the transmitter via the connection set up by the receiver belonging to the group.
